(19) United States
(12) Patent Application Publication
(10) Pub. No.: US 2005/0084204 A1
(43) Pub. Date: Apr. 21, 2005

(54) Digital dyes based on electrochemical redox reactions

(76) Inventors: Zhang-Lin Zhou, Mountain View, CA (US); Xiao-An Zhang, Sunnyvale, CA (US); Kent D. Vincent, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/688,400

(22) Filed: Oct. 16, 2003

(51) Int. Cl. G02B 6/26

(52) U.S. Cl. 385/16

(57) ABSTRACT

A digital dye having an optical change resulting from an electrochemical oxidation/reduction reaction is provided for use in a molecular system. The molecular system provides two different colors based on two different oxidation states of at least one digital dye in the molecular system. Further, an optical switch comprising the molecular system configured within an electric field generated by a pair of electrodes is provided, employing the above-described digital dye. Still further, a display device including a transparent display electrode, a counter electrode, and the molecular system disposed therebetween is provided, where the molecular system comprises at least one digital dye.

### CROSS-REFERENCE TO RELATED APPLICATIONS

The present application is related to application Ser. No. 10/187,720, entitled “Electric Field Actuated Chromogenic Materials Based on Molecules with a Rotating Middle Segment for Applications in Photonic Switching”, and filed on Jul. 1, 2002, in the names of Xiao-An Zhang et al; application Ser. No. 09/898,799, entitled “Bistable Molecular Mechanical Devices Activated by an Electric Field for Electronic Ink and Other Visual Display Applications”, and filed on Jul. 3, 2001, in the names of Xiao-An Zhang et al; and to U.S. Pat. No. 6,556,470, entitled “Field Addressable Rewritable Media”, issued Apr. 29, 2003, to Kent D. Vincent et al, all assigned to the same assignee as the present application, The class of molecules disclosed in the foregoing references has been found to be useful in the optical switching devices of the present application.

The present application is further related to the following applications and patents: Ser. No. 10/187,720, entitled “Electric Field Actuated Chromogenic Materials Based on Molecules with a Rotating Middle Segment for Applications in Photonic Switching”, and filed on Jul. 1, 2002, in the names of Xiao-An Zhang et al; Ser. No. 09/898,799, entitled “Bistable Molecular Mechanical Devices Activated by an Electric Field for Electronic Ink and Other Visual Display Applications”, and filed on Jul. 3, 2001, in the names of Xiao-An Zhang et al; Ser. No. 09/846,135, entitled “Bistable Molecular Mechanical Devices with a Middle Rotating Segment Activated by an Electric Field for Electronic Switching, Gating, and Memory Applications”, and filed on Apr. 30, 2001, in the names of Xiao-An Zhang et al; Ser. No. 09/932,186, entitled “Devices Activated by an Electric Field for Electronic Ink and Other Visual Display Applications”, and filed on Aug. 17, 2001, in the names of Xiao-An Zhang et al; Ser. No. 09/823,195, entitled “Bistable Molecular Mechanical Devices with a Band Gap Change Activated by an Electric Field for Electronic Switching, Gating, and Memory Applications”, and filed on Mar. 29, 2001 in the names of Xiao-An Zhang et al; Ser. No. 09/919,394, entitled “Field Addressable Rewritable Media”, and filed on Jul. 31, 2001, in the names of Kent D. Vincent et al, now U.S. Pat. No. 6,556,470, issued Apr. 29, 2003; and Ser. No. 09/844,862, entitled “Molecular Mechanical Devices with a Band Gap Change Activated by an Electric Field for Optical Switching Applications”, and filed on Apr. 27, 2001, in the names of Xiao-An Zhang et al, all assigned to the same assignee as the present application. The contents of the foregoing patent applications are incorporated herein by reference.

The present application is still further related to the following applications: Ser. No. 10/016,560, entitled “Hard Copy System Including Rewritable Media”, and filed on Oct. 31, 2001, in the names of Kent D. Vincent et al; Ser. No. 09/978,394, entitled “Portable Electronic Reading Apparatus”, and filed on Oct. 16, 2001, in the names of Kent D. Vincent et al; Ser. No. 10/051,669, entitled “Scanning, Copying and Printing with Rewritable Media”, and filed on Jan. 17, 2002, in the names of Kent D. Vincent et al; Ser. No. 09/981,166, entitled “High Resolution Display”, and filed on Oct. 16, 2001, in the names of Kent D. Vincent et al; Ser. No. 10/021,446, entitled “Laser Printing with Rewritable Media”, and filed on Oct. 30, 2001, in the names of Kent D. Vincent et al; and Ser. No. 10/171,060, entitled “Color Display with Molecular Light Valve”, and filed on Jun. 13, 2002, in the names of Kent D. Vincent et al, all assigned to the same assignee as the present application. The contents of the foregoing patent applications are incorporated herein by reference.

### TECHNICAL FIELD

The present invention is related to digital dyes, used in a variety of optical applications, including optical switching, and, more particularly, to digital dyes based on electrochemical oxidation/reduction reactions.

### BACKGROUND ART

Novel molecular switches have been developed capable of changing color from one state to another under the influence of an electric field. In general, the color change occurs through a molecular conformation change that alters the degree of electron conjugation across the molecule and, thereby, its molecular orbital-induced HOMO-LUMO (highest occupied molecular orbital lowest unoccupied molecular orbital) states. In a main embodiment, the conformation change occurs through field rotation of a ring or rings within the molecule. In this instance, the conjugation is broken, or altered, between the rotating rings, called rotors, and ring structures that do not rotate, called stators. The rotors have electric dipoles that induce rotation within a given field. A coupling group (e.g., acetylene) between the rotor and stator elements serves as a “bearing” and conjugation bridge between the rotor and stator.

With such conformation changes, the color can reversibly change from color to colorless (“digital”), although under certain conditions (e.g., incomplete breaking of conjugation), the color can reversibly change from one color to another (“bichromal”). Molecular systems employing such molecules having this capability are defined herein as “digital dyes”, even though there may be a bichromal aspect to them.

The bichromal molecules described in the prior art to date, which involve a change from one color to another color only, are based on an absorptive system, in which the dyes absorb a certain color from ambient light while transmit other colors. In the prior art, there have been published reports regarding special compounds that change their color upon a reversible oxidation and reduction. For example, N-substituted triarylmethane sulfonamides can undergo reversible color changes through a ring opening or closure by the addition of oxidation or reduction agents. Preferred sulfonamides are xanthene sulfonamides having N-aryl substitution, e.g., hydroquino substituents. These types of systems require additional oxidative or reductive agents, thus making the system less practical due to the need for the continuous addition of the redox agents.

There are also reports that certain rare earth metal diphthalocyanines have electrochromic properties, i.e., their color changes in an applied voltage as a result of either oxidation or reduction of the molecule. Normally, the diphthalocyanines are sandwiched between two electrodes. As an example, a lutetium diphthalocyanine layer is formed over ITO (indium tin oxide) display electrodes deposited on a glass substrate. Since the dye is not chemically bonded to the substrate, the required voltage for switching is large and the response color switching time is slow. In some cases, the film of lutetium diphthalocyanine even peels off the underlying electrode.

Besides metal diphthalocyanines, a great deal of work has been carried out on certain inorganic metal oxides, particularly tungsten and molybdenum oxides. These, too, are generally formed as layers over underlying display electrodes and color changes are brought out by the application of an electric potential between the display and a counter electrode through an electrolyte. However, the system needs sulfuric acid or salts as an electrolyte. Thus, it causes dissolution of the tungsten oxide and damage to the electrode due to hydrogen evolution, which could take place at potentials not very different from those associated with the color change.

There is a need for molecular systems that exhibit lower switching voltage, faster switching times, and greater stability than provided by prior art systems.

### DISCLOSURE OF INVENTION

In accordance with the embodiments disclosed herein, a digital dye having an optical change resulting from an electrochemical oxidation/reduction reaction is provided. The digital dye is employed in a molecular system that provides two different colors based on two different oxidation states of at least one digital dye in the molecular system.

Further in accordance with the embodiments disclosed herein, an optical switch comprising the molecular system configured within an electric field generated by a pair of electrodes is provided, employing at least one above-described digital dye.

Still further in accordance with the embodiments disclosed herein, a display device including a transparent display electrode, a counter electrode, and the molecular system, with at least one digital dye, disposed therebetween is provided.

### BRIEF DESCRIPTION OF THE DRAWINGS

FIG. 1 is a schematic cross-section of an electrochromic, or optical, display, device, exemplifying one type of device that employs the molecular systems disclosed herein; and

FIG. 2 is a schematic representation of one embodiment of a molecular system used in a display device, in which a metal complex with a thiol group on both ends connects to a display electrode and counter-electrode.

### BEST MODES FOR CARRYING OUT THE INVENTION

Reference is made now in detail to specific embodiments, which illustrate the best mode presently contemplated for practicing the teachings herein. Alternative embodiments are also briefly described as applicable.

In accordance with the teachings herein, digital dyes based on electrochemical oxidation/reduction (“redox”) reactions are provided. The digital dye comprises a molecular system that provides two different colors based on two different oxidation states of at least one moiety, or segment, in the molecular system by an electrochemical switching method. The switchable molecular system may include metal complexes, charge complexes, and polymer systems.

The basic idea is to introduce a connecting group to an electrochromic molecular system, so that the molecular system either can be chemically bonded to one or both electrodes directly to form a monolayer molecular device for electronic or optical applications or those device molecules can be chemically linked together to form a well organized, multi-layer molecular system for display. The details on how to prepare a well organized, multi-layer thin film molecular system are further disclosed in application Ser. No. 10/465,409, filed Jun. 28, 2003, and Ser. No. 10/614,855, filed Jul. 7, 2003, the contents of which are incorporated herein by reference. A summary of the details on how to prepare the multi-layer thin film molecular system is provided below.

The chemical bonding of the molecular system to one or both electrodes results in devices that have a better electric contact and are more stable, with a smaller voltage needed to achieve oxidation or reduction of the electrochromic molecular system, along with faster response time, compared to prior art redox approaches. Since the oxidation or reduction is achieved electrochemically, the device can be easily switched on and off reversibly and there is no need to add consumable oxidizing or reducing agents; thus, the resulting electrochromic device is more reliable and long lasting.

The present teachings introduce a new type of color switching mechanism of digital dyes, namely, an electrochemical redox reaction of molecular system, which sometimes involves breaking chemical bonds. Some of the molecular systems described herein are readily available. It is also noteworthy that the display device employing electrochemical redox mechanism is easier to build, because it does not require very well oriented molecular layers in the solid films.

The molecular system taught herein is expected to switch between two different color states, such as transparent, red, green, blue, and black, based on different oxidation states of the molecular system, by electrochemical methods. It should find use in a variety of applications, such as display and optical switches.

Scheme 1 below describes a general model of a molecular system containing a metal complex, in which the metal ion is either oxidized or reduced by an electrochemical method, thus providing two different colors: 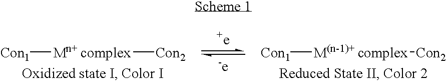
where:
the letters Con₁ and Con₂ represent optional connecting units between one molecule (e.g., digital dye) and another molecule (e.g., digital dye) or between a molecule (e.g., digital dye) and a substrate (e.g., electrode). They can be a single connecting unit or multiple connecting units. They may be any one of the following: hydrogen (utilizing a hydrogen bond), multivalent hetero-atoms (i.e., C, N, O, S, P, etc.) or functional groups containing these hetero atoms (e.g., NH, PH, etc.), hydrocarbons (either saturated or unsaturated), or substituted hydrocarbons; and
the metal complex may be any type containing hetero atoms such as N or P, O, S, Se, Te and/or combination of these hetero atoms, where the metal atom has two different oxidation states.

A metal complex can be represented by the formula: (X)ₙ M L1 L2, (X)₂ M (L1)₂ or (L1)₂ M L2, where n is an integer having a value of 1 to 8, preferably 3 to 5, and wherein M represents a metal atom selected from the metals listed in Groups IIIA, IVA, VA, VIA, VIIA, VIIIA, IB, and IIB of the Periodic Table, more preferably a Group VIII metal; X represents a polar group, such as a halogen atom (such as Cl, Br, or I), a thiocyanate group (SCN), a hydroxy group (OH), a cyan group (CN), an isocyanate group (NCO) or a selenocyan group (SeCN), where the polar group serves to improve the molecular extinction coefficient of the metal complex on a substrate surface, and the letters L1 and L2 represent any hetero atom-containing ligands which have at least one connecting group Con, or Con₂ as defined above. Preferred examples of the hetero atom in such ligands include phosphorus and nitrogen.

Where ligands L1 and L2 contain phosphorus, examples of such phosphorus-containing ligands L1 and L2 include triorganophosphines or triorganophosphites, shown below:

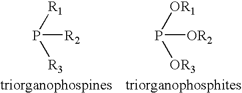

Illustrative triorganophosphine and triorganophosphites ligands may be represented by the formula shown above, wherein each R₁, R₂ or R₃ is the same or different and is a substituted or unsubstituted monovalent hydrocarbon such as alkyl or aryl groups. Suitable hydrocarbon groups may contain from 1 to 24 carbon atoms. Illustrative substituent groups that may be present on the aryl groups include, for example, alkyl, alkoxy, silyl, amino, substituted amino, acyl, carboxyl, acyloxy, amido, sulfonyl, sulfinyl, sulfenyl, as well as halogen, nitro, cyano, trifluoromethyl, and hydroxy. Illustrative alkyl groups include, for example, methyl, ethyl, propyl, butyl and the like. Illustrative aryl groups include, for example, phenyl, naphthyl, diphenyl fluorophenyl, difluorophenyl, benzoyloxyphenyl, carboethoxyphenyl, acetylphenyl, ethoxyphenyl, phenoxyphenyl, hydroxyphenyl, carboxyphenyl, trifluoromethylphenyl, methoxyethylphenyl, acetamidophenyl, dimethylcarbamyphenyl, tolyl, xylyl, and the like.

Illustrative specific organophosphines include, for example, triphenylphosphine, tri-p-tolylphosphine, tris-p-methoxyphenylphosphine, tris-p-fluorophenylphosphine, tris-p-chlorophenylphosphine, tris-dimethylaminophenylphosphine, propyldiphenylphosphine, n-hexyldiphenylphosphine, cyclohexyldiphenylphosphine, dicyclohexylphenylphosphine, tricyclohexylphosphine, tribenzylphosphine as well as (tri-m-sulfophenyl) phosphine and (m-sulfophenyl)diphenylphosphine and the like. A preferred phosphine is triphenylphosphine or substituted triphenylphosphine.

Illustrative specific organophosphites include, for example, trimethylphosphite, triethylphosphite, butyldiethylphosphite, tri-n-propyl phosphite, tri-n-butyl phosphite, tris-2-ethylhexyl phosphite, tri-n-octyl phosphite, tri-n-dodecyl phosphite, dimethylphenyl phosphite, diethyldiphenyl phosphite, triphenyl phosphite, trinaphthyl phosphite, bis(3,6,8-tri-t-butyl-2-naphthyl)methylphosphite, bis(3,6,8-tri-t-butyl-2-naphthyl)phosphite, bis(3,6,8-tri-t-butyl-2-naphthyl)(4-biphenyl)phosphite, bis(3,6,8-tri-t-butyl-2-naphthyl)(4-benzoylphenyl)phosphite, bis(3,6,8-tri-t-butyl-2-naphthyl)(4-sulfonylphenyl)phosphite and the like. A preferred triorganophosphite is triphenylphosphite.

Where the ligands L1 and L2 contain nitrogen, examples of such nitrogen-containing ligands are shown in Scheme 1-1 below: 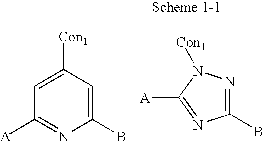
wherein A and B may be the same or different groups independently selected from H and any of the following structures: 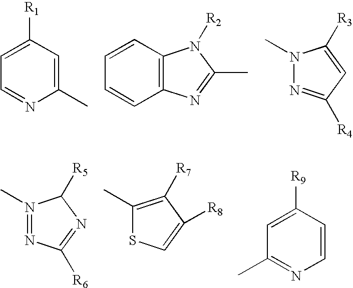
wherein R₁, R₂, R₃, R₄, R₅, R₆, R₇, R₈, and R₉ each independently represent a hydrogen atom or an organic subsistent such as a hydroxyl group, a lower alkyl group such as C₁-C₆ alkyl group, a lower alloy group such as C₁-C₆ alkoxy group, an unsubstituted amino group or an amino group having a substituent such as a lower alkyl group, e.g., C₁-C₆ alkyl group.

The ligands L1 and L2 alternatively are other nitrogen-containing polycyclic compounds such as bipyridines (I), phenanthrolines (II), and biquinolines (III), etc., as shown in Scheme 1-2: 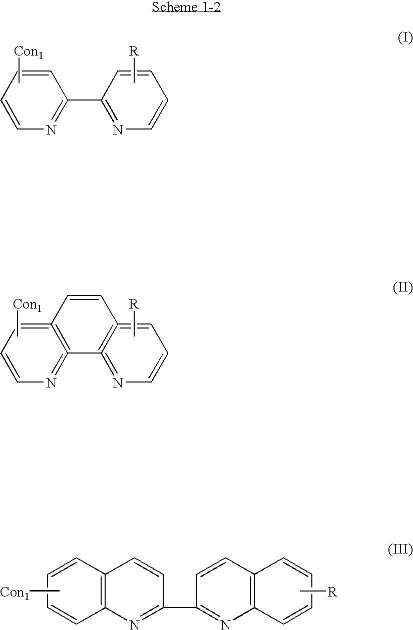
wherein Con₁ is as defined above and R represents a hydrogen atom or an organic substituent such as a hydroxyl group, a lower alkyl group such as C₁-C₆ alkyl group, a lower alkoxy group such as C₁-C₆ alkoxy group, an unsubstituted amino group or an amino group having a substituent such as a lower alkyl group, e.g., C₁-C₆ alkyl group.

Some of the preferred polycyclic nitrogen-containing ligands are listed in the following Scheme 1-3.

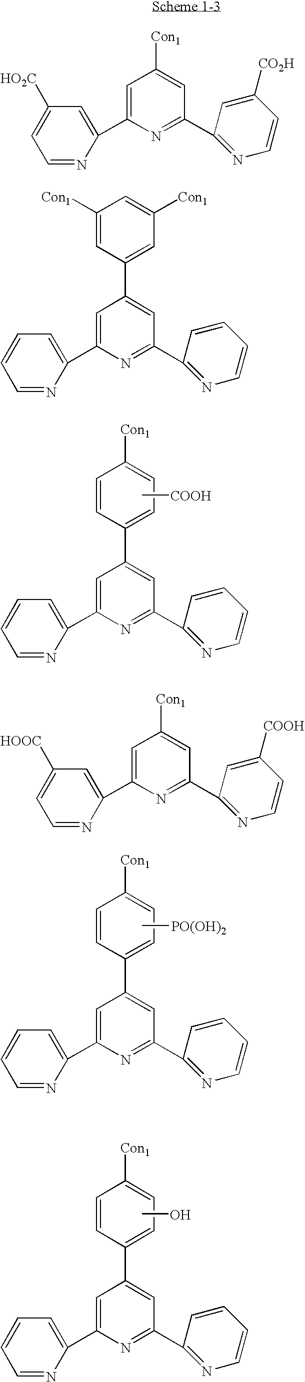

Scheme 1-4 below shows an example of how the metal complex disclosed herein changes its color through a redox reaction:

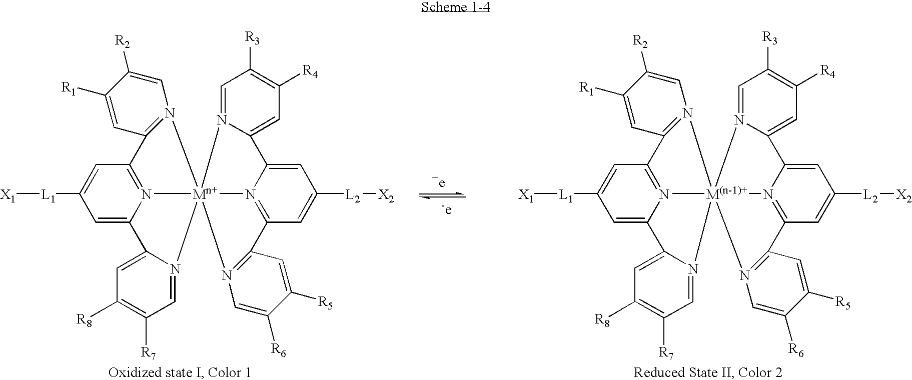

In this example, the letter M represents a Group IIIA, IVA, VA, VIA, VIIA, VIIIA, IB, or IIB metal atom, more preferably a Group VIII metal. The letters L1-X1 and L2-X2 are independently present or absent and, when present, are independently 3-mercaptophenyl, 3-mercaptomethylphenyl, 3-(2-(4-mercaptophenyl)ethynyl)phenyl, 3-(2-(3-mercaptomethylphenyl)ethynyl)phenyl, 3-(2-(3-hydroselenophenyl)ethynyl)phenyl, 3-hydrotellurophenyl, 3-hydrotelluromethylphenyl, 3-(2-(4-hydrotellurophenyl)ethynyl)phenyl, or 3-(2-(3-hydrotellurophenyl)ethynyl)phenyl. The letters R₁, R₂, R₃, R₄, R₅, R₆, R₇, and R₈ are independently selected from the group consisting of a hydrogen atom, hydrocarbons (either saturated or unsaturated), substituted hydrocarbons, aryl groups, substituted aryl groups, or a functional group which contains an atom selected from the group consisting of N, O, S, P, and As.

There are several methods for using these novel materials in optical switches, including displays. An optical switch, as used herein, involves changes in the electro-magnetic properties of the molecules, both within and outside that detectable by the human eye, e.g., ranging from the far infra-red (IR) to deep ultraviolet (UV). Optical switching includes changes in properties such as absorption, reflection, index of refraction, diffraction, and diffuse scattering of electro-magnetic radiation.

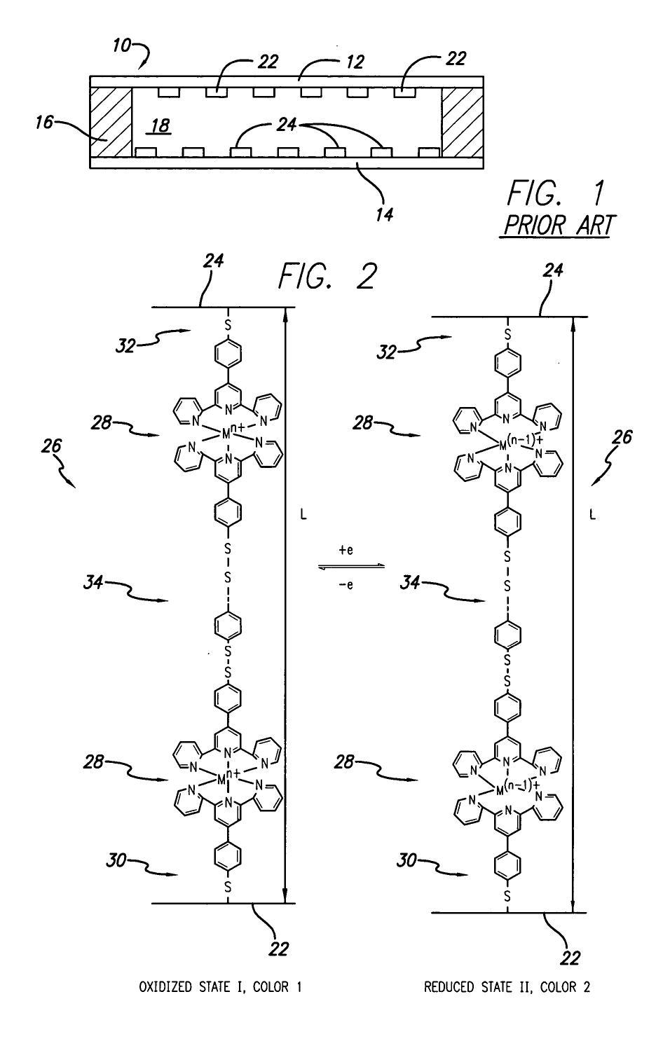

FIG. 1 depicts an example of a generic digital display 10, comprising substantially parallel substrates 12 and 14 of glass or other suitable material sealed together at the periphery by a sealing glass 16 or other bonding material to enclose a hermetic space which contains a colorant layer or film 18. At least substrate 12 of the display 10 is transparent, since the device is intended to be viewed from that side.

Display electrodes 22 are on the inner face of the substrate 12. Counter electrodes 24 are on the inner face of substrate 14. Electrical connection to the display electrodes 22 and the counter electrode 24 are effected by means of a conventional edge connection arrangement, as is well known in the art. The display electrodes 22 are transparent. An example of a suitable material for transparent display electrodes includes indium tin oxide (ITO). The counter electrode 24 may or may not be transparent.

Further details of the display depicted in FIG. 1 are available in U.S. Pat. No. 4,304,465, the contents of which are incorporated herein by reference. However, it will be appreciated that the teachings of the display device disclosed and claimed therein is intended to be exemplary only. Other display devices, and indeed, other optical switches comprising two electrodes and the digital dye therebetween are intended to be encompassed within the ambit of the teachings herein.

Positioned in the hermetic space 18 is the digital dye disclosed herein. The distance between the display electrodes 22 and the counter electrode 24 can be as short as the length dimension L of the digital dyes disclosed herein.

FIG. 2 illustrates an example of a molecular system 26, comprising one or more digital dyes 28. Shown here are two digital dyes 28, as metal complexes, each provided with a thiol 30, 32, one on each end, for connecting the complex to the display electrode 22 and counter electrode 24. Other suitable linking groups may be used in place of the thiol 30, 32, and such linking groups may be the same or different. Examples of such linking groups include, in addition to thiols, thiol-terminated alkenes, and —COOH-terminated chains or groups. The digital dyes 28 are linked together with a linking group 34. The digital dye is switched between oxidation states Mⁿ⁺ (left side) and M⁽ⁿ⁻¹⁾⁺ (right side) by application or switching of an external electric field.

Basically, these newly proposed electrochromic compounds (digital dyes 28) may be deposited and chemically bonded to the display electrodes 22 and counter electrodes 24 by a variety of methods. One approach that may be used is disclosed in the above-referenced application Ser. No. 10/614,855.

The basic concept is to start with “seed” molecules to initiate an organized molecular assembly. The first step is to lay down a Self-Assembled Monolayer (SAM) of “seed” molecules (e.g., thiol 30) on top of the substrate (e.g., upper surface of an electrode, here, electrode 22). The function of the “seed” molecules is to anchor, or adhere, the molecules onto the substrate and to control the molecular orientation with respect to the substrate. This step determines the molecular orientation and orderliness of the subsequent depositions. Next, a monolayer of “active molecules” (e.g., digital dye 28), which is discussed in greater detail below, self-assembles on top of the “seed” monolayer. The final step involves a so-called “spacer” layer (e.g., linker 34), or molecular column, to be deposited on top of the active molecules layer. The last two basic steps could be repeated as many times as necessary so that a molecular thin film structure of the desired thickness can be built up, layer by layer, in a simple and well-controlled manner. Ultimately, a final spacer layer, here, thiol 32, connects the molecular system 26 to electrode 24.

The seed molecules for this type of controllable molecular assembly are typically specially-designed asymmetric bi-functional molecules. At least one of the functional groups has to be capable of self-assembly onto the designated substrate. The other functional group in the seeds should not interfere with or be capable of self-assembly, but it should be able to form a selective connection with specially-designed color switching molecules, or active molecules.

The active molecules are designed in such a way that they have at least one connector unit attached directly onto certain digital dye molecules. In fact, the connector unit(s) belong(s) to part of the digital dye molecule. Each connector in turn must have two or more functional groups, each pointing in different, preferably opposite, directions. All the functional groups in the connector can be identical or different. If they are different, one of the groups must have a much stronger affinity (than the other functional groups) to self-assemble with the seeds already bonded to the substrate. This preferential connecting ability ensures that all the active molecules line up in the same way. On the other hand, in the case of the functional groups in a connector being identical, only one of them will connect with the seeds due to steric effects. In general, the bonding between the functional groups that are connected together can be either physical or chemical.

Currently, as used in digital dyes, it is preferred that the connector unit be away from the edge of the molecules, so that the active molecules are lying down instead of standing up. For other applications, the connector unit can attach directly on the edge of the molecules, so that the molecules preferentially stand up. Furthermore, in digital dye applications, the connector units should not have a significant impact on the overall chromophore or electronic properties of the active molecules.

A third component, the spacer, joins two adjacent layers of active molecules together in a very precise way through two separate self-assembly processes. Chemically, the spacer comprises some special-purpose molecules, ions or atoms that serve as a molecular “glue”.

The three-step controllable organized assembling process permits control of the molecular orientation and the thin film thickness precisely, and this enables the fabrication of a working device with the active molecules. The process uses a simple dipping or immersing method, involving no expensive or high-precision equipment. The entire process can be easily scaled up to industrial process, such as roll-to-roll for large-scale industrial production.

It will be noted that the active molecules are generally custom-designed with certain desired characteristics, be it storage or display, whereas the spacers and seeds are generally off-the-shelf compounds or sometimes custom-designed. The active molecules are so engineered that they form certain connections, preferably via ionic bonds or metal chelation, with certain functional groups in the spacers or seeds. As a requirement, the active molecules, spacers, and seeds in this organized assembly must be soluble in certain appropriate solvents or mixed-solvents so that the process of self-assembly can take place. However, once self-assembled onto their counterparts, such molecules will not back-dissolve in the reagent solutions during the subsequent processing steps. This will ensure the production of a high quality 3-D thin film by this controllable, organized assembly method.

Alternatively, the digital dyes, or electrochromic molecules, may be included in a semiconductive organic layer comprising conventional charge transport materials as common to organic light emitting diodes and organic photoconductors, for example. For example, substituted triarylamines may be used for hole transport materials and aluminum complexes may be used for electron-transport material as shown in the following scheme

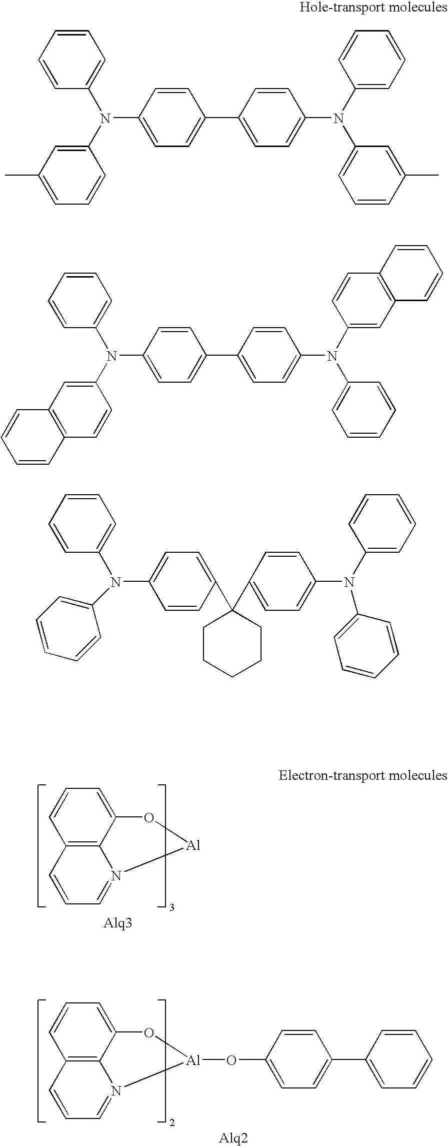

The colorant layer 18 in the device generally has a thickness L of about 0.05 to 1.0 μm, typically about 0.2 to 1 μm. The lower value is dictated by the extinction coefficient of the molecular system 26: a higher extinction coefficient enables use of a smaller thickness.

The film 18 of the molecular system 26 can be prepared in a number of ways. One preferred method is to deposit a monolayer of the digital dye 28 on the display electrode 22 through a self-assembly method, using linking group 30 to attach the digital dye 28 to the display electrode. Self-assembly methods are well known in this art. Then, a second layer of the molecule 28 is deposited through an oxidative coupling method via the S—S linkage 34 as shown in FIG. 2, and this process is repeated until the film 18 attains the desired thickness L. The other end of the molecular system 26 is then attached to the counter electrode 24 via linking group 32.

Scheme 2 below depicts another general example of a molecular system for use as digital dyes. In this case, the molecular system contains a metal complex and a chromophore dye, in which the metal ion could be either oxidized or reduced by an electrochemical method, thus providing two different colors. In this molecular system, the metal complex and the chromophore dye are connected via a chemical bond through a ligand. 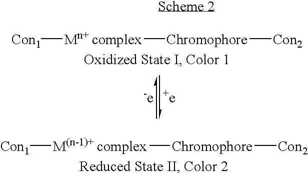
where:
The letters Con₁ and Con₂ are as defined above.

The metal complex is as defined above, represented by the formula: (X)ₙ M L1 L2, (X)₂ M (L1)₂ or (L1)₂ M L2, wherein M and X are as defined above, and wherein the value of n and the letters L1 and L2 are as defined above in Schemes 1-1 and 1-2.

Some of the preferred polycyclic nitrogen-containing ligands are listed in the foregoing Scheme 1-3.

Many of the known natural or synthetic chromophores can be used in the digital dye. The chromophores, which can be used for connection with the metal complex, are classified into following several groups based on their chemical structures:

(a) Dyes based on polyenes and polymethines. Polyene and polymethine dyes are characterized by a chain of methane groups (—CH═), i.e., by a system of conjugated double bonds. In polymethine dyes, an electron donor D and an electron acceptor A terminate the chain of methine groups (GF1), whereas in polyene dyes, alkyl or other groups that do not influence the electronic excitation of the dye are characteristic for the chain ends. Aza nitrogen (—N═) may replace one or more methine groups in the chain. The polymethines can be further subdivided into cyanine/isocyanine (both A and D contain nitrogen in the rings as depicted in GF2), hemicyanine (GF3), streptocyanine (GF4) and oxonol (GF5). GF1, GF2, GF3, GF4 and GF5 are general formulas for subdivided polymethines dyes. 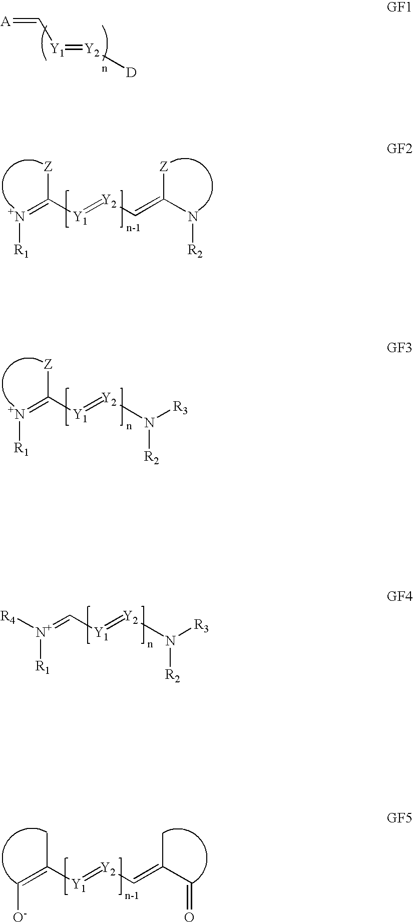
where:

The letter A is an Acceptor group; it is an electron-withdrawing group. It may be one of following: carboxylic acid or its derivatives, sulfuric acid or its derivatives, phosphoric acid or its derivatives, nitro, nitrile, hetero atoms (e.g., N, O, S, P, F, Cl, Br), functional groups with at least one of above-mentioned hetero atoms (e.g., OH, SH, NH, etc.), hydrocarbons (either saturated or unsaturated), or substituted hydrocarbons.

The letter D represents a Donor group; it is an electron-donating group. It may be one of following: hydrogen, amine, OH, SH, ether, hydrocarbon (either saturated or unsaturated), or substituted hydrocarbon or functional group with at least one of hetero atom (e.g., B, Si, I, N, O, S, P). The donor is differentiated from the acceptor by that fact that it is less electronegative, or more electropositive, than the acceptor group on the molecule.

The letters R₁, R₂, R₃ and R₄ are property-tuning units. They may be any one of the following: hydrogen, multivalent hetero-atoms (i.e., C, N, O, S, P, etc.) or functional groups containing these hetero atoms (e.g., NH, PH, etc.), hydrocarbons (either saturated or unsaturated) or substituted hydrocarbons.

The letter Z represents an optional bridging unit. The function of this bridging unit is to connect the two adjacent aromatic rings together. It can be O, S, NH₂, NHR or CHR functional group.

The letters Y₁ and Y₂ represent connecting units between donor and acceptor. They may or may not be identical. Y₁ and Y₂ can be either CH═ or N═ units, and the Y₁=Y₂ can be a single connecting set or multiple connecting sets.

(b) Polyarylmethine dyes and their aza analogs. The polyarylmethines can be grouped into diarylmethines and triarylmethines category (GF6). Both di- and tri-arylmethines can be further subdivided into with bridged on two adjacent aryl ring (GF7 and GF9) or none bridged (GF6 and GF8) on two adjacent aryl ring and their aza analogs (when Y═N in GF8 and GF9). GF6, GF7, GF8 and GF9 are general formulas for subdivided polyarylmethines dyes. 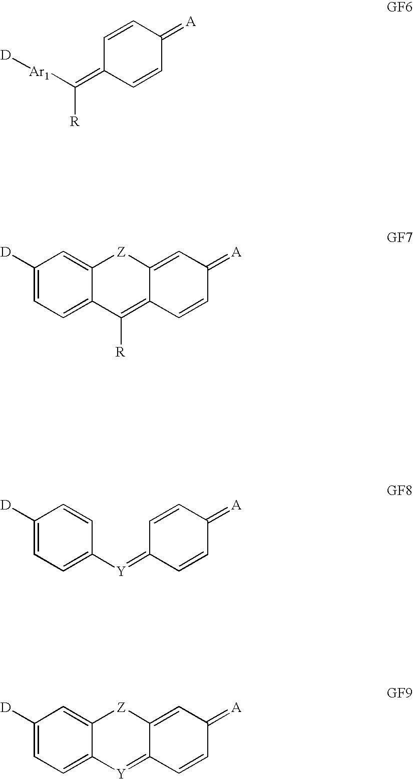
where:

A and D are as defined above, and the letter Y represents a connecting unit between the donor and acceptor, and can be either a CH═ or N═ unit.

Z represents an optional bridging unit. The function of this bridging unit is to connect the two adjacent aromatic rings together. It can be O, S, NH₂, NHR or CHR functional group.

Ar₁ is aromatic ring system.

R may be any one of the following: hydrogen, hydrocarbon (either saturated or unsaturated) or substituted hydrocarbon.

(c) Aza [18] annulenes and phthalocyanine colorants.

(d) Nitro and nitroso dyes, where one or more electron donor group(s) and nitro (or nitroso) group(s) are linked together through an aromatic ring.

(e) Azo dyes and pigments. Azo related colorants are compounds containing (—N═N—) which are linked sp²-hybridized carbon atoms. The azo groups are mainly bound to aromatic rings, but in some cases, they are also aromatic heterocycles (e.g., pyrazole) or enolizable aliphatic groups (e.g., acetoacetic acid derivatives).

(f) Carbonyl dyes and pigments. These colorants are characterized by at least two carbonyl groups that are bound to sp²-hybridized carbon atoms. The carbonyl groups are conjugated as shown in the general formula (GF10) where the n can be between 1 to 4, and R₁, R₂, R₃, and R₄ can be hydrogen atom, alkyl group, aryl group, or a functional group which contains a N, O, S, P, and/or As atom. R₁, R₂, R₃ and R₄ may or may not be identical and they can be linked together (as in anthraquinone; its general formula is depicted in GF12) or be separate (as in indigo depicted in GF11). GF10, GF11 and GF12 are general formulas for carbonyl colorants: 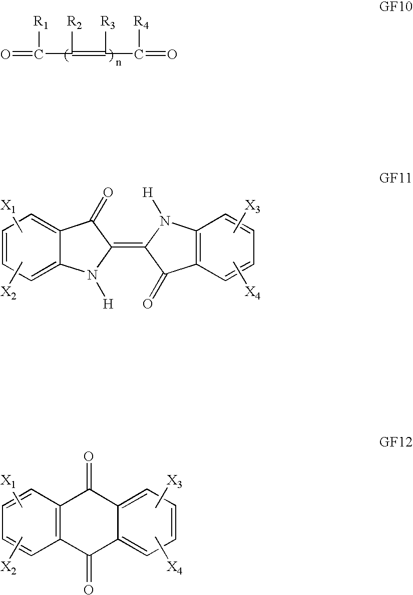
where:

n=1 to 4.

X₁, X₂, X₃, and X₄ are some auxochromic tuning units. They may be any one of the following: hydrogen, multivalent hetero-atoms (i.e., C, N, O, S, P, etc.) or functional groups containing these hetero atoms (e.g., NH, PH, etc.), hydrocarbons (either saturated or unsaturated) or substituted hydrocarbons.

R₁, R₂, R₃, and R₄ may be any one of the following: hydrogen, hydrocarbons (either saturated or unsaturated) or substituted hydrocarbons.

(g) BODIPY (4,4-difluoro-4-bora-3a,4a-diaza-s-indacene) dyes. The basic structure of the BODIPY dye is shown in GF13. 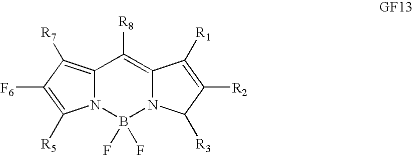
where:

The letters R₁, R₂, R₃, R₄, R₅, R₆, R₇, and R₈ can be hydrogen atom, hydrocarbons (either saturated or unsaturated) or substituted hydrocarbons, aryl group and substituted aryl groups, or a functional group which contains N, O, S, P, and/or As atom. R₁, R₂, R₃, R₄, R₅, R₆, R₇, and R₈ may or may not be identical.

Scheme 2-1 shows an example of how the metal complex GF13 connected with a chromophore changes its color upon a redox reaction.

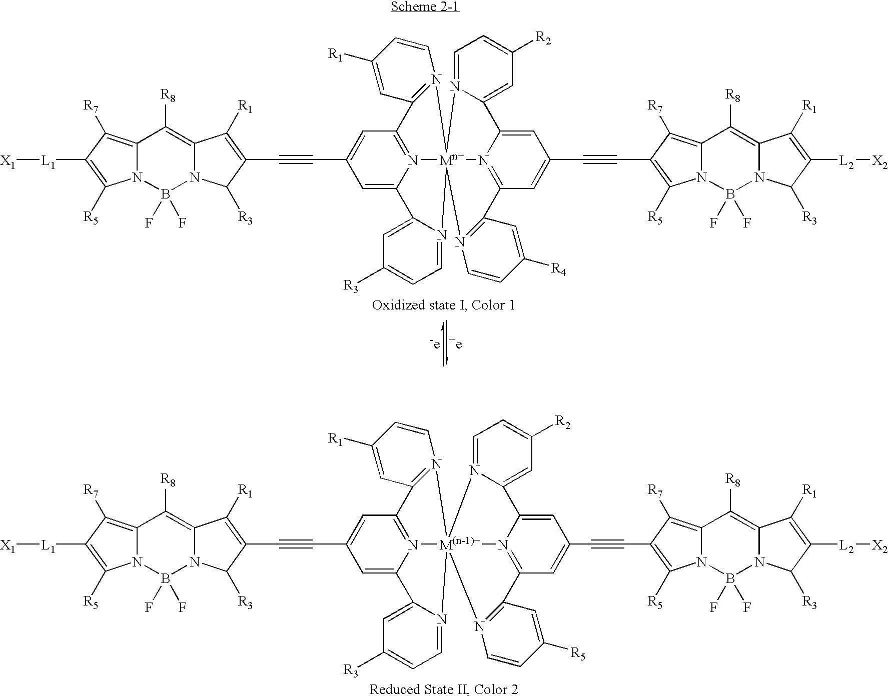

In a preferred embodiment, the letter M represents a Group IIIA, IVA, VA, VIA, VIIA, VIIIA, IB or IIB metal atom, more preferably a Group VIII metal. The letters L1-X1 and L2-X2 are independently present or absent and, when present, are independently 3-mercaptophenyl, 3-mercaptomethylphenyl, 3-(2-(4-mercaptophenyl)ethynyl)phenyl, 3-(2-(3-mercaptomethylphenyl)ethynyl)phenyl, 3-(2-(3-hydroselenophenyl)ethynyl)phenyl, 3-hydrotellurophenyl, 3-hydrotelluromethylphenyl and 3-(2-(4-hydrotellurophenyl)ethynyl)phenyl, or 3-(2-(3-hydrotellurophenyl)ethynyl)phenyl. The letters R₁, R₂, R₃, R₄, R₅, R₆, R₇, and R₈ can be hydrogen atom, hydrocarbons (either saturated or unsaturated) or substituted hydrocarbons, aryl group and substituted aryl groups, or a functional group which contains a N, O, S, P, and/or As atom. R₁, R₂, R₃, R₄, R₅, R₆, R₇, and R₈ may or may not be identical.

Another type of metal complex that is useful in the digital dyes herein is a cyclic hetero-atom containing ligand with the metal atom in the center as shown in the following Scheme 2-2. These metal complexes (A) and (B) contain metal atoms that do not have different oxidation states such as IA and IIA metal ions. In this connection, different colors are achieved through oxidation or reduction of the ligands, thus breaking or forming the metal complexes to give two distinct colors. 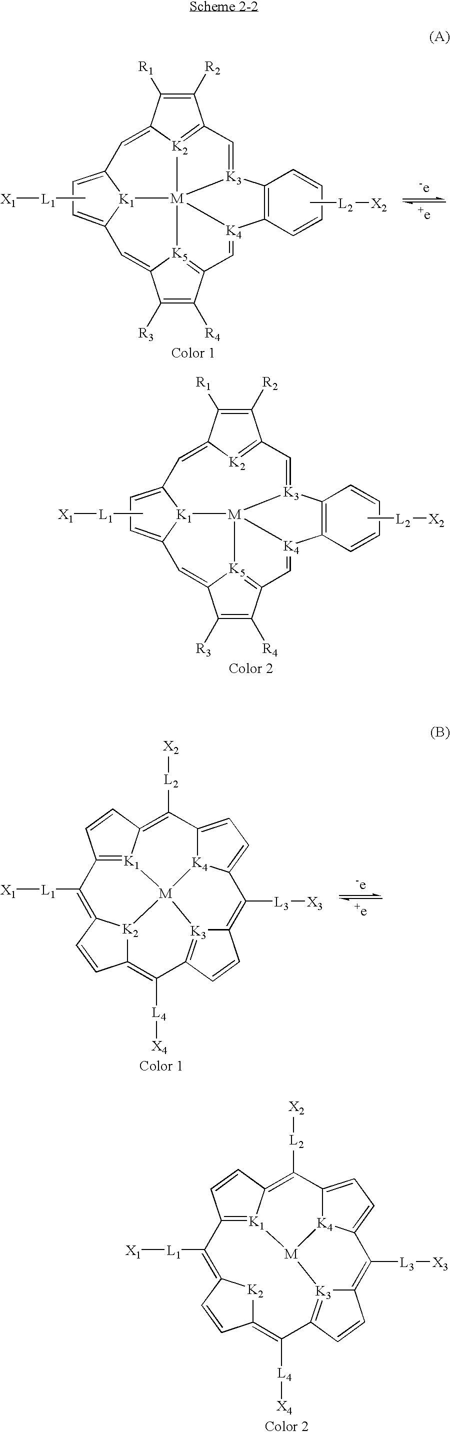
where

K1, K2, K3, K4, and K5 are independently selected from the group consisting of N, O, S, Se, Te and CH; M is a metal; L1, L2, L3, and L4 are independently present or absent, when present, are linkers; and X1, X2, X3, and X4 are independently selected from the group consisting of a substrate, a reactive site that can covalently couple to a substrate, and a reactive site that can ionically couple to a substrate. In some of the embodiments, L-X can be eliminated and/or replaced with a substituent independently selected from various substituents such as aryl, phenyl, cycloalkyl, alkyl, halogen, alkoxy, alkylthio, perfluoroalkyl, perfluoroaryl, pyridyl, cyano, thiocyanate, nitro, amino, alkylamino, acyl, sulfoxyl, sulfonyl, imido, amido, and carbamoyl. Preferred substituents provide a redox potential range of less than about 5 volts, preferably less than about 2 volts, more preferably less than about 1 volt. R1, R2, R3, and R4 are independently selected from various substituents such as aryl, phenyl, cycloalkyl, alkyl, halogen, alkoxy, alkylthio, perfluoroalkyl, perfluoroaryl, pyridyl, cyano, thiocyanate, nitro, amino, alkylamino, acyl, sulfoxyl, sulfonyl, imido, amido, and carbamoyl. Preferred substituents provide a redox potential range of less than about 5 volts, preferably less than about 2 volts, more preferably less than about 1 volt.

In preferred embodiments, M is IA and IIA metal ions, preferably, M⁺ is Li⁺, Na⁺, K⁺, Mg²⁺, or Ca²⁺. In certain preferred embodiments, L1-X1, L2-X2, L3-X3, and L4-X4 are independently present or absent and, when, present, are independently 3-mercaptophenyl, 3-mercaptomethylphenyl, 3-(2-(4 mercapto-phenyl)ethynyl)phenyl, 3-(2-(3-mercaptomethylphenyl)ethynyl)phenyl, 3-(2-(3-hydroselenophenyl)ethynyl)phenyl, 3-hydrotellurophenyl, 3-hydrotelluromethylphenyl and 3-(2-(4-hydrotellurophenyl)ethynyl)phenyl, or 3-(2-(3-hydrotellurophenyl)ethynyl)phenyl.

Another example of molecular systems that are useful for digital dyes are those conductive polymers that can be either oxidized or reduced electrochemically and reversibly, thus providing two distinct colors as shown in Scheme 3. Even though conductive polymers have been reported for electrochromic displays, no one has been able to chemically connect the conductive polymer to the electrode. In this scheme, the conductive polymer is attached to the electrode via a chemical bond; thus, the device will have better electric contact and also fast response time.

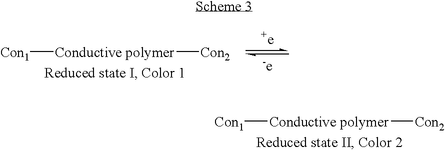

The conducting polymers that can be used for digital dyes are shown in the following Scheme 3-1:

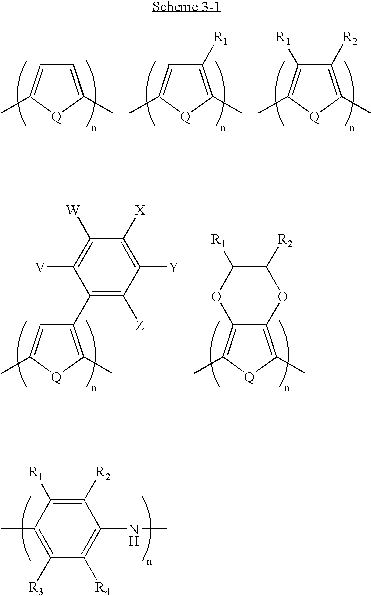

where: Q represents a heteroatom such as N, O, Se, and Te, etc. and R₁, R₂, R₃, R₄, V, W, X, Y, and Z are independently absent or present. When present, they are independently selected from various substituents such as aryl, phenyl, cycloalkyl, alkyl, halogen, alkoxy, alkylthio, perfluoroalkyl, perfluoroaryl, pyridyl, cyano, thiocyanate, nitro, amino, alkylamino, acyl, sulfoxyl, sulfonyl, imido, amido, and carbamoyl. Preferred substituents provide a redox potential range of less than about 5 volts, preferably less than about 2 volts, more preferably less than about 1 volt. Examples of such a conducting polymer are polymers obtained by electrolytic oxidative polymerization, chemical oxidative polymerization or photooxidative polymerization of heterocyclic compounds, such as pyrrole, pyrrole derivatives having a substituent at the nitrogen atom or the 3- and/or 4-positions thereof, thiophene, thiophene derivatives having a substituent at the 3- and/or 4-positions thereof; or aromatic compounds, such as anilines, alkyl-substituted anilines, phenol, thiophenol, and derivatives thereof; and poly(p-phenylene), polyacetylene, etc.

The technology disclosed and claimed herein for forming optical switches (micro-meter or nanometer) may be used to assemble displays, electronic books, rewritable media, electrically tunable optical lenses, electrically controlled tinting for windows and mirrors, optical crossbar switches for routing signals from one of many incoming channels to one of many outgoing channels, and more.

In particular, an optical switch comprises the digital dye disclosed herein, configured within an electric field generated by a pair of electrodes. The molecular system can change between a transparent state and a colored state or between one colored state and another colored state. Alternatively, the molecular system can change between one index of refraction and another index of refraction.

### INDUSTRIAL APPLICABILITY

The digital dyes disclosed herein are expected to find use in a variety of optical applications, including, but not limited to, optical switches and specifically digital displays.

1. A digital dye having an optical change resulting from an electrochemical oxidation/reduction reaction, said digital dye employed in a molecular system that provides two different colors based on two different oxidation states of at least one said digital dye in said molecular system.

2. The digital dye of claim 1 wherein said at least one digital dye comprises a metal complex.

3. The digital dye of claim 2 wherein said molecular system is based on the general model below: 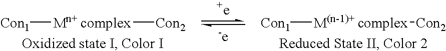
where
Con₁ and Con₂ are optional connecting units between one molecule and another molecule or between a molecule and a substrate, are either a single connecting unit or multiple connecting units, and are selected from the group consisting of hydrogen (utilizing a hydrogen bond), multivalent hetero-atoms selected from the group consisting of C, N, O, S, and P, functional groups containing said hetero atoms, saturated or unsaturated hydrocarbons, and substituted hydrocarbons; and
said metal complex contains hetero atoms selected from the group consisting of N, P, O, S, Se, and Te and combinations thereof, where M has two different oxidation states.

4. The digital dye of claim 3 wherein said metal complex is represented by one of the following formulae:
(X)ₙ M L1 L2,
(X)₂ M (L1)₂, or
(L1)₂ M L2,
wherein M represents a metal atom selected from the metals listed in Groups IIIA, IVA, VA, VIA, VIIA, VIIIA, IB, and IIB of the Periodic Table, X represents a polar group, L1 and L2 represent any hetero atom containing ligands which have at least one said connecting group Con₁ or Con₂, and n is an integer between 1 and 8.

5. The digital dye of claim 4 wherein M is a Group VIII metal and wherein X is selected from the group consisting of halogen, thiocyanate, hydroxy, cyan, isocyanate, and selenocyan.

6. The digital dye of claim 4 wherein L1 and L2 are selected from the group consisting of 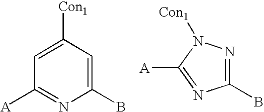
wherein A and B may be the same or different groups independently selected from H and any of the following structures: 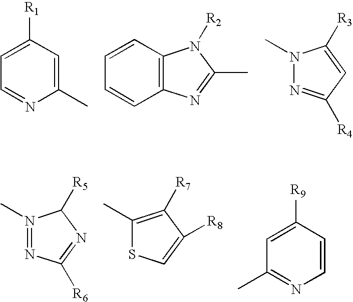
wherein R₁, R₂, R₃, R₄, R₅, R₆, R₇, R₈ and R₉ each represents a hydrogen atom or an organic subsistent such as a hydroxyl group, a lower alkyl group such as C₁-C₆ alkyl group, a lower alloy group such as C₁-C₆ alkoxy group, an unsubstituted amino group or an amino group having a substituent such as a lower alkyl group, e.g., C₁-C₆ alkyl group.

7. The digital dye of claim 6 wherein L1 and L2 are independently selected from the group consisting of

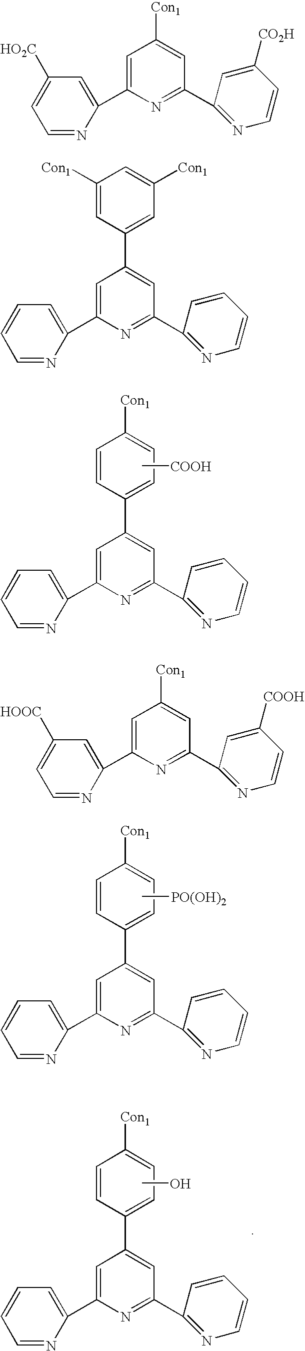

8. The digital dye of claim 4 wherein L1 and L2 are nitrogen-containing polycyclic compounds selected from the group consisting of bipyridines (I), phenanthrolines (II), and biquinolines (III): 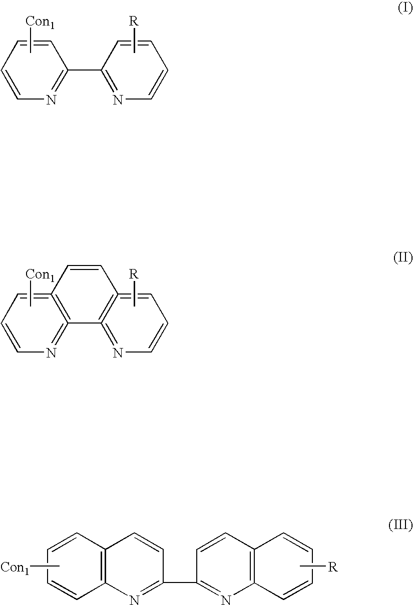
where R represents a hydrogen atom or an organic substituent selected from the group consisting of hydroxyl, C₁-C₆ alkyl group, C₁-C₆ alkoxy group, an unsubstituted amino group, and an amino group having said substituent.

9. The digital dye of claim 4 wherein L1 and L2 are selected from the group consisting of triorganophosphines and triorganophosphites having the formula 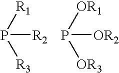
where each R₁, R₂ or R₃ is the same or different and is a substituted or unsubstituted monovalent hydrocarbon selected from the group consisting of alkyl and aryl groups.

10. The digital dye of claim 9 wherein said hydrocarbon groups contain from 1 to 24 carbon atoms and wherein said substituted aryl group contains substituent groups selected from the group consisting of alkyl, alkoxy, silyl, amino, substituted amino, acyl, carboxyl, acyloxy, amido, sulfonyl, sulfinyl, sulfenyl, halogen, nitro, cyano, trifluoromethyl, and hydroxy.

11. The digital dye of claim 10 wherein said alkyl groups are selected from the group consisting of methyl, ethyl, propyl, and butyl, wherein said aryl groups are selected from the group consisting of phenyl, naphthyl, diphenyl fluorophenyl, difluorophenyl, benzoyloxyphenyl, carboethoxyphenyl, acetylphenyl, ethoxyphenyl, phenoxyphenyl, hydroxyphenyl, carboxyphenyl, trifluoromethylphenyl, methoxyethylphenyl, acetamidophenyl, dimethylcarbamyphenyl, tolyl, and xylyl.

12. The digital dye of claim 9 wherein said organophosphine is selected from the group consisting of triphenylphosphine, tri-p-tolylphosphine, tris-p-methoxyphenylphosphine, tris-p-fluorophenylphosphine, tris-p-chlorophenylphosphine, tris-dimethylaminophenyl-phosphine, propyldiphenylphosphine, n-hexyldiphenylphosphine, cyclohexyldiphenylphosphine, dicyclohexylphenylphosphine, tricyclohexylphosphine, tribenzylphosphine as well as (tri-m-sulfophenyl) phosphine, and (m-sulfophenyl)-diphenylphosphine.

13. The digital dye of claim 9 wherein said organophosphites is selected from the group consisting of trimethylphosphite, triethylphosphite, butyidiethylphosphite, tri-n-propyl phosphite, tri-n-butyl phosphite, tris-2-ethylhexyl phosphite, tri-n-octyl phosphite, tri-n-dodecyl phosphite, dimethylphenyl phosphite, diethyldiphenyl phosphite, tri-phenyl phosphite, trinaphthyl phosphite, bis(3,6,8-tri-t-butyl-2-naphthyl)methyl-phosphite, bis(3,6,8-tri-t-butyl-2-naphthyl)phosphite, bis(3,6,8-tri-t-butyl-2-naphthyl)(4-biphenyl)phosphite, bis(3,6,8-tri-t-butyl-2-naphthyl)(4-benzoylphen-yl)phosphite, and bis(3,6,8-tri-t-butyl-2-naphthyl)(4-sulfonylphenyl)phosphite.

14. The digital dye of claim 4 wherein said digital dye is represented by 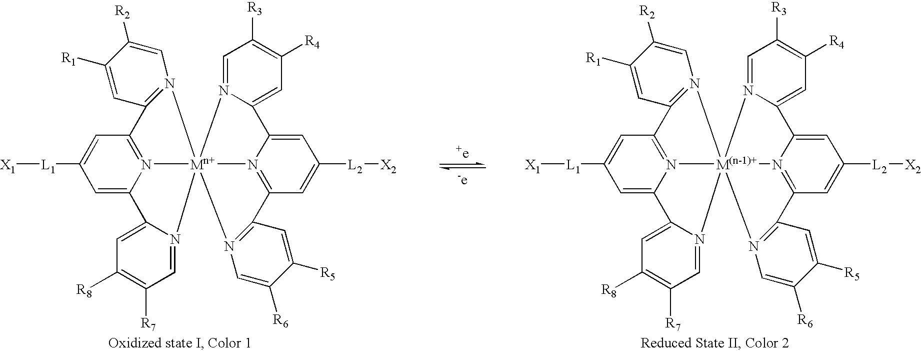
where
L1-X1 and L2-X2 are independently present or absent, and if present are independently selected from the group consisting of 3-mercaptophenyl, 3-mercaptomethylphenyl, 3-(2-(4-mercaptophenyl)ethynyl)-phenyl, 3-(2-(3-mercap-tomethylphenyl)ethynyl) phenyl, 3-(2-(3-hydroselenophenyl)ethynyl)phenyl, 3-hydrotellurophenyl, 3-hydrotelluromethylphenyl, 3-(2(4-hydrotellurophenyl)-ethynyl)phenyl, and 3-(2-(3-hydrotellurophenyl)ethynyl)phenyl; and
R₁, R₂, R₃, R₄, R₅, R₆, R₇, and R₈ are independently selected from the group consisting of a hydrogen atom, hydrocarbons (either saturated or unsaturated), substituted hydrocarbons, aryl groups, substituted aryl groups, and a functional group which contains at least one atom selected from the group consisting of N, O, S, P, and As.

15. The digital dye of claim 1 wherein said at least one digital dye comprises a charge complex.

16. The digital dye of claim 15 wherein said molecular system is based on the general model below: 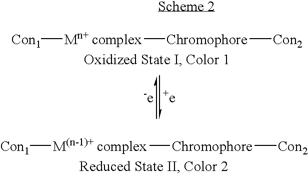
where:
Con₁ and Con₂ are optional connecting units between one molecule and another molecule or between a molecule and a substrate, are either a single connecting unit or multiple connecting units, and are selected from the group consisting of hydrogen (utilizing a hydrogen bond), multivalent hetero-atoms selected from the group consisting of C, N, O, S, and P, functional groups containing said hetero atoms, saturated or unsaturated hydrocarbons, and substituted hydrocarbons;
said metal complex contains at least one hetero atom selected from the group consisting of N, P, O, S, Se, and Te, where M has two different oxidation states; and
said chromophore is a natural or synthetic colorant.

17. The digital dye of claim 16 wherein said metal complex is represented by one of the following formulae:
(X)ₙ M L1 L2,
(X)₂ M (L1)₂, or
(L1)₂ M L2,
wherein M represents a metal atom selected from the metals listed in Groups IIIA, IVA, VA, VIA, VIIA, VIIIA, IB, and IIB of the Periodic Table, X represents a polar group, and L1 and L2 represent any hetero atom containing ligands which have at least one said connecting group Con₁ or Con₂, and n is an integer between 1 and 8.

18. The digital dye of claim 17 wherein M is a Group VIII metal and wherein X is selected from the group consisting of halogen, thiocyanate, hydroxy, cyan, isocyanate, and selenocyan.

19. The digital dye of claim 17 wherein L1 and L2 are selected from the group consisting of 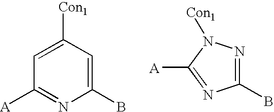
wherein A and B may be the same or different groups independently selected from H and any of the following structures: 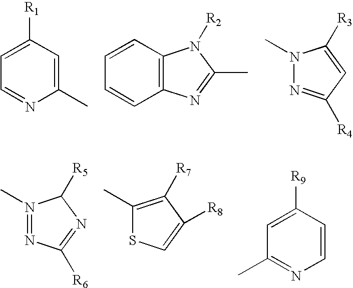
wherein R₁, R₂, R₃, R₄, R₅, R₆, R₇, R₈ and R₉ each represents a hydrogen atom or an organic subsistent such as a hydroxyl group, a lower alkyl group such as C₁-C₆ alkyl group, a lower alloy group such as C₁-C₆ alkoxy group, an unsubstituted amino group or an amino group having a substituent such as a lower alkyl group, e.g., C₁-C₆ alkyl group.

20. The digital dye of claim 19 wherein L1 and L2 are independently selected from the group consisting of

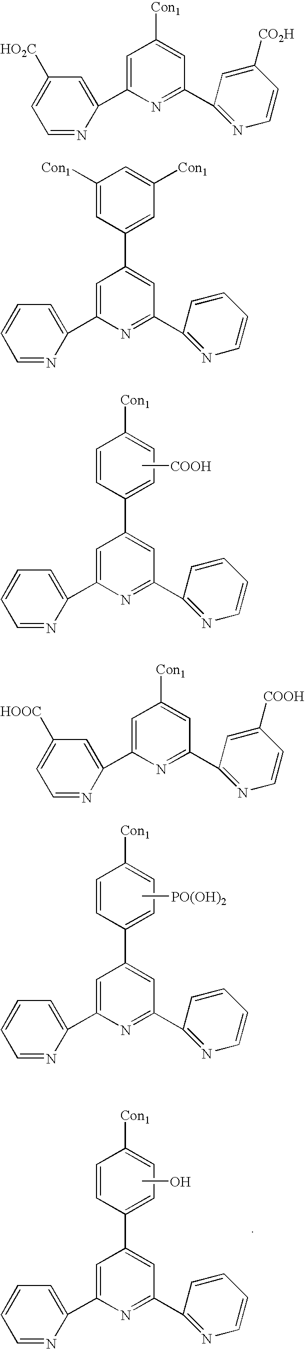

21. The digital dye of claim 17 wherein L1 and L2 are nitrogen-containing polycyclic compounds selected from the group consisting of bipyridines (I), phenanthrolines (II), and biquinolines (III): 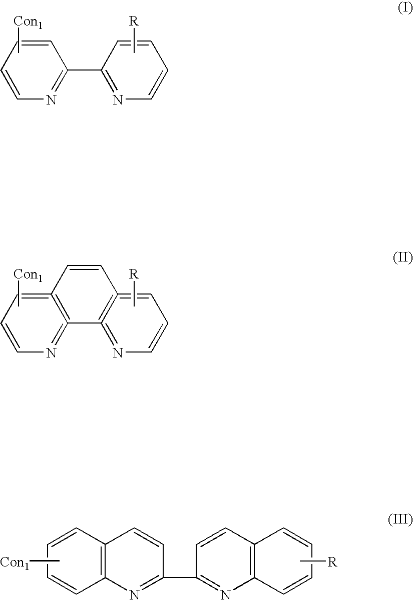
where R represents a hydrogen atom or an organic substituent selected from the group consisting of hydroxyl, C₁-C₆ alkyl group, C₁-C₆ alkoxy group, an unsubstituted amino group, and an amino group having said substituent.

22. The digital dye of claim 17 wherein L1 and L2 are selected from the group consisting of triorganophosphines and triorganophosphites having the formula 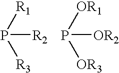
where each R₁, R₂ or R₃ is the same or different and is a substituted or unsubstituted monovalent hydrocarbon selected from the group consisting of alkyl and aryl groups.

23. The digital dye of claim 22 wherein said hydrocarbon groups contain from 1 to 24 carbon atoms and wherein said substituted aryl group contains substituent groups selected from the group consisting of alkyl, alkoxy, silyl, amino, substituted amino, acyl, carboxyl, acyloxy, amido, sulfonyl, sulfinyl, sulfenyl, halogen, nitro, cyano, trifluoromethyl and hydroxy.

24. The digital dye of claim 23 wherein said alkyl groups are selected from the group consisting of methyl, ethyl, propyl, and butyl, wherein said aryl groups are selected from the group consisting of phenyl, naphthyl, diphenyl fluorophenyl, difluorophenyl, benzoyloxyphenyl, carboethoxyphenyl, acetylphenyl, ethoxyphenyl, phenoxyphenyl, hydroxyphenyl, carboxyphenyl, trifluoromethylphenyl, methoxyethylphenyl, acetamidophenyl, dimethylcarbamyphenyl, tolyl, and xylyl.

25. The digital dye of claim 22 wherein said organophosphines are selected from the group consisting of triphenylphosphine, tri-p-tolylphosphine, tris-p-methoxyphenylphosphine, tris-p-fluorophenylphosphine, tris-p-chlorophenylphosphine, tris-dimethylaminophenyl-phosphine, propyldiphenylphosphine, n-hexyldiphenylphosphine, cyclohexyldiphenylphosphine, dicyclohexylphenylphosphine, tricyclohexylphosphine, tribenzylphosphine as well as (tri-m-sulfophenyl) phosphine, and (m-sulfophenyl)-diphenylphosphine.

26. The digital dye of claim 22 wherein said organophosphites are selected from the group consisting of trimethylphosphite, triethylphosphite, butyldiethylphosphite, tri-n-propyl phosphite, tri-n-butyl phosphite, tris-2-ethylhexyl phosphite, tri-n-octyl phosphite, tri-n-dodecyl phosphite, dimethylphenyl phosphite, diethyldiphenyl phosphite, tri-phenyl phosphite, trinaphthyl phosphite, bis(3,6,8-tri-t-butyl-2-naphthyl)methyl-phosphite, bis(3,6,8-tri-t-butyl-2-naphthyl)phosphite, bis(3,6,8-tri-t-butyl-2-naphthyl)(4-biphenyl)phosphite, bis(3,6,8-tri-t-butyl-2-naphthyl)(4-benzoylphen-yl)phosphite, and bis(3,6,8-tri-tbutyl-2-naphthyl)(4-sulfonylphenyl)phosphite.

27. The digital dye of claim 17 wherein said colorant is selected from the group consisting of (a) dyes based on polyenes and polymethines; (b) polyarylmethine dyes and their aza analogs; (c) aza[18] annulenes and phthalocyanine colorants; (d) nitro and nitroso dyes; (e) azo dyes and pigments; (f) carbonyl dyes and pigments; and (g) BODIPY dyes.

28. The digital dye of claim 27 wherein said dyes based on polyenes and polymethines are selected from the group consisting of 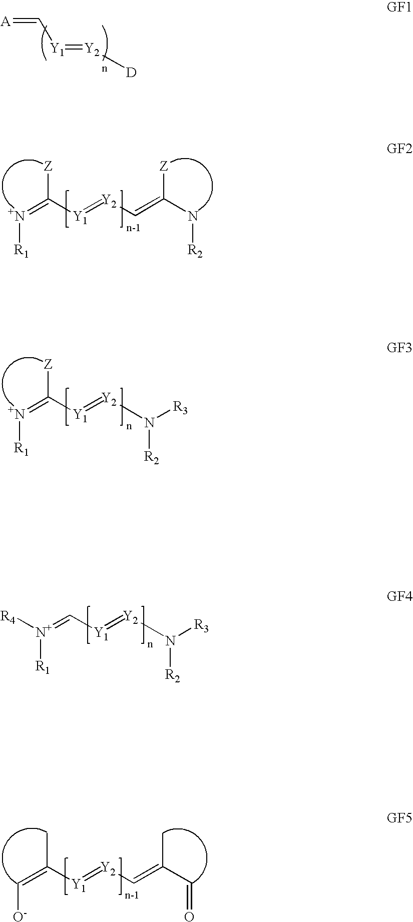
where:
A is an Acceptor group comprising an electron-withdrawing group selected from the group consisting of (a) carboxylic acid and its derivatives, (b) sulfuric acid and its derivatives, (c) phosphoric acid and its derivatives, (d) nitro, (e) nitrile, (f) hetero atoms selected from the group consisting of N, O, S. P, F, Cl, Br), (g) functional groups with at least one of said hetero atoms, (h) saturated or unsaturated hydrocarbons, and (i) substituted hydrocarbons;
D is a Donor group comprising an electron-donating group selected from the group consisting of (a) hydrogen, (b) amines, (c) OH, (d) SH, (e) ethers, (f) saturated or unsaturated hydrocarbons, (g) substituted hydrocarbons, and (h) functional groups with at least one hetero atom selected from the group consisting of B, Si, I, N, O, S, and P, wherein said Donor group is more electropositive than said Acceptor group;
R₁, R₂, R₃, and R₄ are property-tuning units selected from the group consisting of (a) hydrogen, (b) multivalent hetero-atoms selected from the group consisting of C, N, O, S, and P, (c) functional groups with at least one of said hetero atoms, (d) saturated or unsaturated hydrocarbons, and (d) substituted hydrocarbons;
Z is an optional bridging unit for connecting two adjacent aromatic rings together, selected from the group consisting of O, S, NH₂, NHR, and CHR functional groups; and
Y₁ and Y₂ represent connecting units between said Donor and said Acceptor, and are independently selected from the group consisting of CH═ and N═ units, wherein Y₁=Y₂ can be a single connecting set or multiple connecting sets.

29. The digital dye of claim 27 wherein said polyarylmethine dyes and their aza analogs are selected from the group consisting of 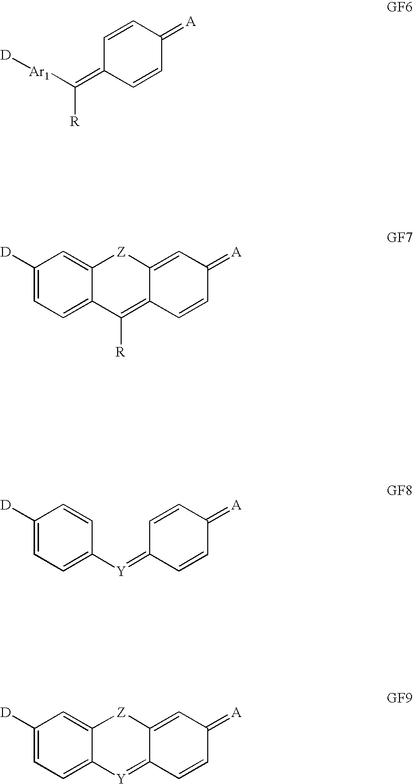
where:
A is an Acceptor group comprising an electron-withdrawing group selected from the group consisting of (a) carboxylic acid and its derivatives, (b) sulfuric acid and its derivatives, (c) phosphoric acid and its derivatives, (d) nitro, (e) nitrile, (f) hetero atoms selected from the group consisting of N, O, S. P, F, Cl, Br), (g) functional groups with at least one of said hetero atoms, (h) saturated or unsaturated hydrocarbons, and (i) substituted hydrocarbons;
D is a Donor group comprising an electron-donating group selected from the group consisting of (a) hydrogen, (b) amines, (c) OH, (d) SH, (e) ethers, (f) saturated or unsaturated hydrocarbons, (g) substituted hydrocarbons, and (h) functional groups with at least one hetero atom selected from the group consisting of B, Si, I, N, O, S, and P, wherein said Donor group is more electropositive than said Acceptor group;
Y is a connecting unit between said Donor and said Acceptor, and is either a CH═ or N═ unit;
Z is an optional bridging unit for connecting two adjacent aromatic rings together, selected from the group consisting of O, S, NH₂, NHR, and CHR functional group;
Ar₁ is aromatic ring system; and
R is selected from the group consisting of hydrogen, saturated or unsaturated hydrocarbon, and substituted hydrocarbon.

30. The digital dye of claim 27 wherein in said nitro and nitroso dyes, at least one electron donor groups and at least one nitro group or at least one nitroso group are linked together through an aromatic ring.

31. The digital dye of claim 27 wherein said azo dyes and pigments are compounds containing (—N═N—) which are linked sp²-hybridized carbon atoms, wherein said azo groups are either bound to aromatic rings, are aromatic heterocycles or are enolizable aliphatic groups.

32. The digital dye of claim 27 wherein said carbonyl dyes and pigments have at least two carbonyl groups that are bound to sp²-hybridized carbon atoms and are selected from the group consisting of 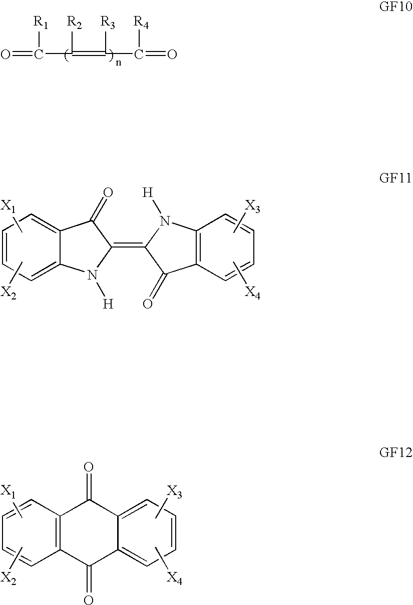
where:
n=1 to 4;
X₁, X₂, X₃, and X₄ are some auxochromic tuning units. They may be any one of the following: hydrogen, multivalent hetero-atoms (i.e., C, N, O, S, P, etc.) or functional groups containing these hetero atoms (e.g., NH, PH, etc.), hydrocarbons (either saturated or unsaturated) or substituted hydrocarbons; and
R₁, R₂, R₃, and R₄ may be any one of the following: hydrogen, hydrocarbons (either saturated or unsaturated) or substituted hydrocarbons.

33. The digital dye of claim 27 wherein said BODIPY dye has a structure given by 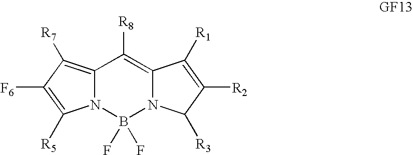
wherein
R₁, R₂, R₃, R₄, R₅, R₆, R₇, and R₈ are independently selected from the group consisting of hydrogen atom, saturated or unsaturated hydrocarbons, substituted hydrocarbons, aryl groups substituted aryl groups, and a functional group containing an atom selected from the group consisting of N, O, S, P, and As.

34. The digital dye of claim 17 wherein said digital dye is represented by 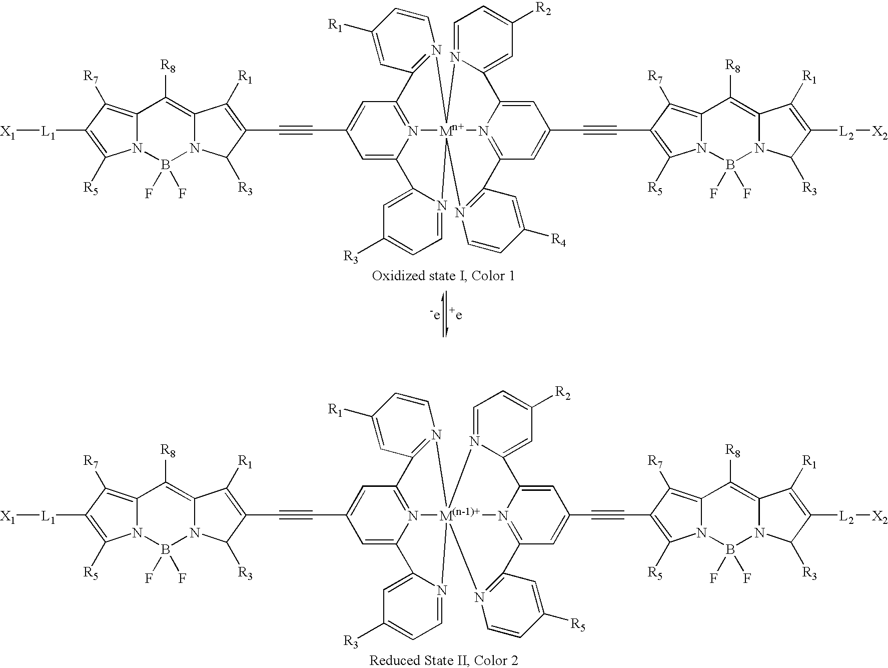
where
L1-X1 and L2-X2 are independently present or absent and if present are independently 3-mercaptophenyl, 3-mercaptomethylphenyl, 3-(2-(4-mercaptophenyl)ethynyl)phenyl, 3-(2-(3-mercaptomethylphenyl)ethynyl)-phenyl, 3-(2-(3-hydroselenophenyl)ethynyl)phenyl, 3-hydrotellurophenyl, 3-hydrotelluromethylphenyl and 3-(2-(4-hydrotellurophenyl)ethynyl)phenyl, or 3-(2-(3-hydrotellurophenyl)ethynyl)phenyl; and
R₁, R₂, R₃, R₄, R₅, R₆, R₇, and R₈ are independently selected from the group consisting of hydrogen atom, saturated or unsaturated hydrocarbons, substituted hydrocarbons, aryl groups, substituted aryl groups, and functional groups which contains at least one atom selected from the group consisting of N, O, S, P, and As.

35. The digital dye of claim 17 wherein said molecular system is represented by either molecular system (A) or molecular system (B): 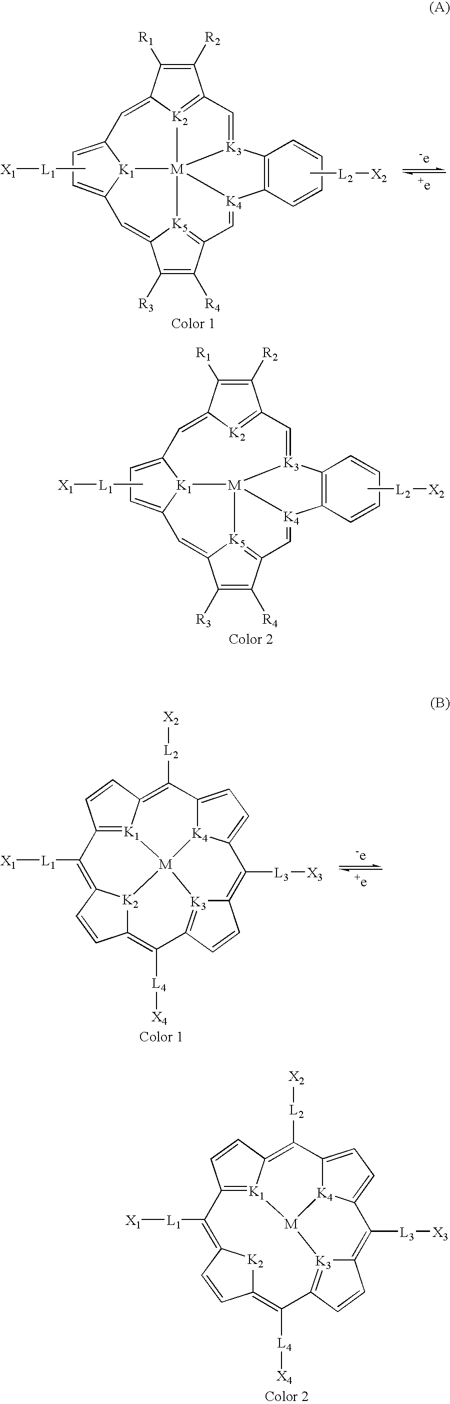
where
K1, K2, K3, K4, and K5 are independently selected from the group consisting of N, O, S, Se, Te, and CH;
M is a metal;
L1, L2, L3, and L4 are independently present or absent and if present are linkers;
X1, X2, X3, and X4 are independently selected from the group consisting of a substrate, a reactive site that can covalently couple to a substrate, and a reactive site that can ionically couple to a substrate; and
R1, R2, R3, and R4 are independently selected from the group consisting of aryl, phenyl, cycloalkyl, alkyl, halogen, alkoxy, alkylthio, perfluoroalkyl, perfluoroaryl, pyridyl, cyano, thiocyanate, nitro, amino, alkylamino, acyl, sulfoxyl, sulfonyl, imido, amido, and carbamoyl.

36. The digital dye of claim 35 wherein said R groups together provide a redox potential range of less than about 5 volts.

37. The digital dye of claim 36 wherein said redox potential range is less than about 2 volts.

38. The digital dye of claim 37 wherein said redox potential range is less than about 1 volt.

39. The digital dye of claim 35 wherein L-X groups can either be eliminated or replaced with at least one substituent independently selected from substituents selected from the group consisting of aryl, phenyl, cycloalkyl, alkyl, halogen, alkoxy, alkylthio, perfluoroalkyl, perfluoroaryl, pyridyl, cyano, thiocyanate, nitro, amino, alkylamino, acyl, sulfoxyl, sulfonyl, imido, amido, and carbamoyl.

40. The digital dye of claim 39 wherein said substituents together provide a redox potential range of less than about 5 volts.

41. The digital dye of claim 40 wherein said redox potential range is less than about 2 volts.

42. The digital dye of claim 41 wherein said redox potential range is less than about 1 volt.

43. The digital dye of claim 35 wherein M⁺ is selected from the group consisting of Li⁺, Na⁺, K⁺, Mg²⁺, and Ca²⁺.

44. The digital dye of claim 35 wherein L1-X1, L2-X2, L3-X3, and L4-X4 are independently present or absent and if present are independently 3-mercaptophenyl, 3-mercaptomethylphenyl, 3-(2-(4-mercaptophenyl)ethynyl)phenyl, 3-(2-(3-mercaptomethylphenyl)ethynyl)phenyl, 3-(2-(3-hydroselenophenyl)ethynyl)phenyl, 3-hydrotellurophenyl, 3-hydrotelluromethylphenyl and 3-(2-(4-hydrotellurophenyl)ethynyl)phenyl, and 3-(2-(3-hydrotellurophenyl)ethynyl)phenyl.

45. The digital dye of claim 1 wherein said at least one digital dye comprises a conducting polymer system.

46. The digital dye of claim 45 wherein said molecular system is based on the general model below: 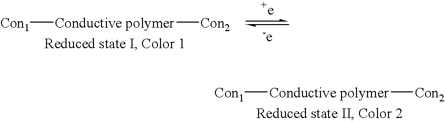
where
Con₁ and Con₂ are optional connecting units between one molecule and another molecule or between a molecule and a substrate, are either a single connecting unit or multiple connecting units, and are selected from the group consisting of hydrogen (utilizing a hydrogen bond), multivalent hetero-atoms selected from the group consisting of C, N, O, S, and P, functional groups containing said hetero atoms, saturated or unsaturated hydrocarbons, and substituted hydrocarbons; and
said conductive polymer is a polymer that can be either oxidized or reduced electrochemically and reversibly.

47. The digital dye of claim 46 wherein said conductive polymer is selected from the group consisting of 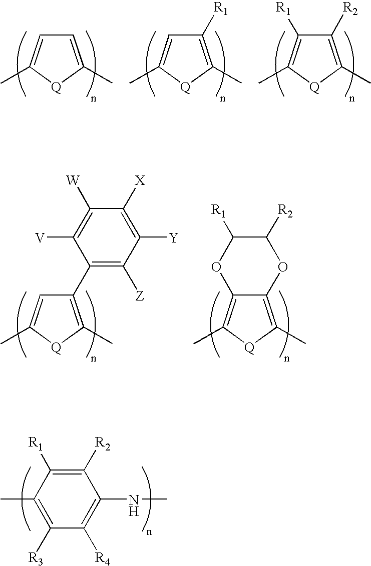
where:
Q is a heteroatom selected from the group consisting of N, O, Se, and Te; and
R₁, R₂, R₃, R₄, V, W, X, Y, and Z are substituents that are independently absent or present and if present are independently selected from the group consisting of aryl, phenyl, cycloalkyl, alkyl, halogen, alkoxy, alkylthio, perfluoroalkyl, perfluoroaryl, pyridyl, cyano, thiocyanate, nitro, amino, alkylamino, acyl, sulfoxyl, sulfonyl, imido, amido, and carbamoyl.

48. The digital dye of claim 47 wherein said substituents together provide a redox potential range of less than about 5 volts.

49. The digital dye of claim 48 wherein said redox potential range is less than about 2 volts.

50. The digital dye of claim 49 wherein said redox potential range is less than about 1 volt.

51. The digital dye of claim 46 wherein said conducting polymer is a polymer that is obtained by electrolytic oxidative polymerization, by chemical oxidative polymerization or by photooxidative polymerization of heterocyclic compounds.

52. The digital dye of claim 51 wherein said heterocyclic compound is selected from the group consisting of (a) pyrrole, (b) pyrrole derivatives having a substituent at the nitrogen atom or the 3- and/or 4-positions thereof, (c) thiophene, (d) thiophene derivatives having a substituent at the 3- and/or 4-positions thereof; (e) aromatic compounds selected from the group consisting of anilines, alkyl-substituted anilines, phenols, thiophenols, and derivatives thereof, (f) poly(p-phenylene), and (g) polyacetylene.

53. The digital dye of claim 1 wherein said digital dye has two ends and includes a linking group on at least one said end to form said molecular system.

54. The digital dye of claim 53 wherein said chemical bonding is achieved with terminal groups on said digital dye selected from the group consisting of thiols, thiol-terminated alkenes, and —COOH-terminated chains or groups.

55. The digital dye of claim 1 wherein said molecular system includes at least one said digital dye.

56. The molecular system of claim 55 wherein each said at least one digital dye has two ends, and further including a linking group on at least one said end.

57. An optical switch comprising a molecular system disposed between a pair of electrodes capable of generating an electric field, said molecular system providing two different colors based on two different oxidation states of at least one said digital dye in said molecular system, said digital dye having an optical change resulting from an electrochemical oxidation/reduction reaction.

58. The optical switch of claim 57 wherein said molecular system changes between a transparent state and a colored state.

59. The optical switch of claim 57 wherein said molecular system changes between one colored state and another colored state.

60. The optical switch of claim 57 wherein said molecular system changes between one index of refraction and another index of refraction.

61. The optical switch of claim 57 for assembling devices selected from the group consisting of displays, electronic books, rewritable media, electrically tunable optical lenses, electrically controlled tinting for windows and mirrors, and optical crossbar switches for routing signals from one of many incoming channels to one of many outgoing channels.

62. A display device including a transparent display electrode, a counter electrode, and a molecular system disposed therebetween, said molecular system providing two different colors based on two different oxidation states of at least one said digital dye in said molecular system, said digital dye having an optical change resulting from an electrochemical oxidation/reduction reaction.

63. The display device of claim 62 wherein said molecular system is chemically bonded to at least one of said electrodes.

64. The display device of claim 63 wherein said molecular system is chemically bonded to both said electrodes.

65. The display device of claim 63 wherein said chemical bonding is achieved with terminal groups on said digital dye selected from the group consisting of thiols, thiol-terminated alkenes, and —COOH-terminated chains or groups.

66. The display device of claim 62 wherein said at least one digital dye comprises a metal complex.

67. The display device of claim 64 wherein said molecular system is based on the general model below: 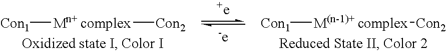
where
Con₁ and Con₂ are optional connecting units between one molecule and another molecule or between a molecule and a substrate, are either a single connecting unit or multiple connecting units, and are selected from the group consisting of hydrogen (utilizing a hydrogen bond), multivalent hetero-atoms selected from the group consisting of C, N, O, S, and P, functional groups containing said hetero atoms, saturated or unsaturated hydrocarbons, and substituted hydrocarbons; and
said metal complex contains hetero atoms selected from the group consisting of N, P, O, S, Se, and Te and combinations thereof, where M has two different oxidation states.

68. The display device of claim 67 wherein said metal complex is represented by one of the following formulae:
(X)ₙ M L1 L2,
(X)₂ M (L1)₂, or
(L1)₂ M L2,
wherein M represents a metal atom selected from the metals listed in Groups IIIA, IVA, VA, VIA, VIIA, VIIIA, IB, and IIB of the Periodic Table, X represents a polar group, L1 and L2 represent any hetero atom containing ligands which have at least one said connecting group Con₁ or Con₂, and n is an integer between 1 and 8.

69. The display device of claim 62 wherein said at least one digital dye comprises a charge complex.

70. The display device of claim 69 wherein said molecular system is based on the general model below: 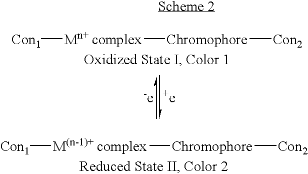
where:
Con₁ and Con₂ are optional connecting units between one molecule and another molecule or between a molecule and a substrate, are either a single connecting unit or multiple connecting units, and are selected from the group consisting of hydrogen (utilizing a hydrogen bond), multivalent hetero-atoms selected from the group consisting of C, N, O, S, and P, functional groups containing said hetero atoms, saturated or unsaturated hydrocarbons, and substituted hydrocarbons;
said metal complex contains at least one hetero atom selected from the group consisting of N, P, O, S, Se, and Te, where M has two different oxidation states; and
said chromophore is a natural or synthetic colorant.

71. The display device of claim 70 wherein said metal complex is represented by one of the following formulae:
(X)ₙ M L1 L2,
(X)₂ M (L1)₂, or
(L1)₂ M L2,
wherein M represents a metal atom selected from the metals listed in Groups IIIA, IVA, VA, VIA, VIIA, VIIIA, IB, and IIB of the Periodic Table, X represents a polar group, and L1 and L2 represent any hetero atom containing ligands which have at least one said connecting group Con₁ or Con₂, and n is an integer between 1 and 8.

72. The display device of claim 62 wherein said at least one digital dye comprises a conducting polymer system.

73. The display device of claim 72 wherein said molecular system is based on the general model below: 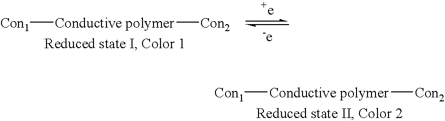
where
Con₁ and Con₂ are optional connecting units between one molecule and another molecule or between a molecule and a substrate, are either a single connecting unit or multiple connecting units, and are selected from the group consisting of hydrogen (utilizing a hydrogen bond), multivalent hetero-atoms selected from the group consisting of C, N, O, S, and P, functional groups containing said hetero atoms, saturated or unsaturated hydrocarbons, and substituted hydrocarbons; and
said conductive polymer is a polymer that can be either oxidized or reduced electrochemically and reversibly.
